(19) United States
(12) Patent Application Publication
(10) Pub. No.: US 2026/0192514 A1
(43) Pub. Date: Jul. 9, 2026

(54) PRINTER HEAD ARRANGEMENT, 3D-PRINTED OBJECT AND METHOD FOR 3D PRINTING

(71) Applicant: SIGNIFY HOLDING B.V., EINDHOVEN (NL)

(72) Inventors: ROBERT VAN ASSELT, VALKENSWAARD (NL); RIFAT ATA MUSTAFA HIKMET, EINDHOVEN (NL)

(21) Appl. No.: 18/868,939

(22) PCT Filed: Jun. 9, 2023
(86) PCT No.: PCT/EP2023/065550

§ 371 Date: Nov. 25, 2024

(30) Foreign Application Priority Data
Jun. 14, 2022 (EP) 22178918.3

(51) Int. Cl. B29C 64/209; B29C 64/118; B33Y 10/00; B33Y 30/00; B33Y 80/00

(52) U.S. Cl. CPC B29C 64/209; B29C 64/118; B33Y 10/00; B33Y 30/00; B33Y 80/00

(57) ABSTRACT

A printer head arrangement (100) for a 3D-printing apparatus, a 3D-printed object (450) and a 3D-printing method (500) are provided. The printer head arrangement comprises a first nozzle (110) arranged to move linearly along an axis, x, and to deposit a first printing material (120) in a first direction, A, perpendicular to the axis, x, and to create layers (130) of deposited first printing material stacked in a direction, z, opposite to the first direction, A, a second nozzle (140) arranged to deposit a second printing material (150) on one side (160) of the layers of deposited first printing material, wherein a normal, N, of the side extends perpendicular to the direction, z, wherein the first and second nozzles are arranged at a predetermined distance, D, parallel to the first direction, A, from each other, and wherein the nozzles are configured to simultaneously deposit the first and second printing materials.

### FIELD OF THE INVENTION

The present invention generally relates to the field of 3D printing. More specifically, the present invention relates to a printer head arrangement for a 3D printing apparatus, a 3D-printed object, and a method for 3D printing.

### BACKGROUND OF THE INVENTION

Additive manufacturing, sometimes also referred to as 3D printing, refers to processes used to synthesize a three-dimensional object. 3D printing is rapidly gaining popularity because of its ability to perform rapid prototyping without the need for assembly or molding techniques to form the desired article.

By using a 3D printing apparatus, articles or objects may be built in three dimensions in a number of printing steps that are usually controlled by a computer model. For example, a sliced 3D model of the object may be provided in which each slice is recreated by the 3D printing apparatus in a discrete printing step. The 3D printing apparatus may deposit successive layers of an extrudable material from a dispenser, and the layers may be cured or otherwise hardened after deposition, e.g. using a laser to induce the curing process. An example of such a 3D printing apparatus is disclosed in US 2010/0327479 A1.

The most widely used additive manufacturing technology is the process known as Fused Deposition Modeling (FDM). FDM is an additive manufacturing technology commonly used for modeling, prototyping, and production applications. FDM works on an “additive” principle by depositing material in layers. Other terms for FDM are “fused filament fabrication” (FFF) or “filament 3D printing” (FDP), which are considered to be equivalent to FDM. In general, FDM printers use a thermoplastic filament, which is heated to its melting point and then extruded, layer by layer, (or in fact filament after filament) to create a three-dimensional object. FDM printers are relatively fast and can be used for printing relatively complicated or complex objects. Alternatively, direct FDM from pellet or granulate materials can be performed (also referred to as pellet printing or FGF (Fused Granulate Fabrication).

However, FDM may suffer from the problem of cracking of the deposited material due to stress built up in the printed object as a result of differential cooling. One or more additional processing steps may possibly be suggested in order to avoid this, but it should be noted that additional processing steps lead to operational inefficiency regarding time and/or cost.

Hence, alternative solutions are of interest, which are able to efficiently and conveniently produce objects via FDM, wherein these objects have a reduced built-in stress.

### SUMMARY OF THE INVENTION

It is an object of the present invention to mitigate the above problems and to provide an arrangement and a method for creating objects by FDM, wherein these objects have a reduced built-in stress compared to objects produced by FDM according to the prior art.

This and other objects are achieved by providing a printer head arrangement and a method having the features in the independent claims. Preferred embodiments are defined in the dependent claims.

Hence, according to a first aspect of the present invention, there is provided a printer head arrangement for a 3D-printing apparatus, comprising at least one first nozzle arranged to move linearly along an axis, x, and to deposit a first printing material in a first direction, A, perpendicular to the axis, x, and to create layers of deposited first printing material stacked in a direction, z, opposite to the first direction, A. The printer head arrangement further comprises at least one second nozzle arranged to deposit a second printing material on at least one side of the layers of deposited first printing material, wherein a normal, N, of the at least one side extends perpendicular to the axis, x, and perpendicular to the direction, z. The at least one first nozzle and the at least one second nozzle are arranged at a predetermined distance, D, parallel to the first direction, A, from each other, and wherein the at least one first nozzle and the at least one second nozzle are configured to simultaneously deposit the first printing material and the second printing material, respectively.

According to a second aspect of the present invention, there is provided a 3D-printed object. The 3D-printed object comprises a plurality of layers of deposited first printing material, wherein each layer of the plurality of layers at least partially extends along an axis, x, wherein the plurality of layers is stacked in a direction, z, perpendicular to the axis, x, and wherein the plurality of layers comprises at least one side portion, wherein a normal, N, of the at least one side portion extends perpendicular to the axis, x, and perpendicular to the direction, z. The at least one side of the plurality of layers comprises at least one furrow between at least one pair of adjacent layers of the plurality of layers, wherein the at least one furrow extends parallel to the axis, x. The 3D-printed object further comprises deposited second printing material provided in at least a portion of the at least one furrow.

According to a third aspect of the present invention, there is provided a 3D-printing method comprising the steps of: providing a printer head arrangement comprising at least one first nozzle and at least one second nozzle, linearly moving the at least one first nozzle along an axis, x, and depositing, by the at least one first nozzle, a first printing material in a first deposit direction, A, perpendicular to the axis, x, creating layers of deposited first printing material stacked in a direction, z, opposite to the first direction, A, depositing, by the at least one second nozzle, a second printing material on at least one side of the layers of deposited first printing material, wherein a normal, N, of the at least one side extends perpendicular to the first direction, z, wherein the at least one first nozzle and the at least one second nozzle are arranged at a predetermined distance, D, parallel to the first direction, A, from each other, and wherein the depositing of the first printing material and the depositing of the second printing material are performed simultaneously.

Thus, the present invention according to the first aspect is based on the idea of providing a printer head arrangement for a 3D-printing apparatus which is able to reduce built-in stress in the 3D-printed object by the dual nozzle arrangement, wherein the first nozzle(s) and the second nozzle(s) are oriented differently and arranged at a predetermined distance, D, from each other. It should be noted that the second aspect of the present invention shares the same common general inventive concept with the first aspect of the present invention, as the 3D-printed object has a reduced built-in stress. Accordingly, the third aspect of the present invention shares the same common general inventive concept with the first and second aspects of the present invention, as the method is able to create a 3D-printed object with a reduced built-in stress.

The present invention is advantageous in that the printer head arrangement for a 3D-printing apparatus is able to avoid built-in stress in the 3D-printed object in an efficient and convenient manner. Compared to a single nozzle arrangement, in which the deposited printing material starts to cool down from the surface immediately after deposition, the dual-nozzle arrangement according to the present invention achieves a spread of the cooling of the printed material over a longer time and/or a larger area, leading to reduced levels of stress built up within the 3D-printed object.

The present invention is further advantageous in that the printer head arrangement deposits (extrudes) the first printing material simultaneously with the second printing material, i.e. during the same movement of the printer head arrangement in one (single) process. The present invention may hereby avoid any additional processing step for stress-reducing purposes. It will be appreciated that additional processing steps may comprise mechanical after-treatments of the surfaces of the object and/or applications of auxiliary fluids and/or material, which may lead to increases in manufacturing cost and/or time. In comparison, the printer head arrangement of the present invention, on the other hand, leads to a cost- and/or time-saving operation.

It will be appreciated that the mentioned advantages of the printer head arrangement of the first aspect of the present invention also hold for the 3D-printed object according to the second aspect of the present invention and the method according to the third aspect of the present invention.

The printer head arrangement for a 3D-printing apparatus according to the first aspect of the present invention comprises at least one first nozzle arranged to move linearly along an axis, x, and to deposit a first printing material in a first direction, A, perpendicular to the axis, x. For example, a filament of the first printing material may be deposited from the first nozzle. By the term “printing material”, it is here meant a material which can be extruded, e.g. a plastic material. Hence, the first nozzle(s) is (are) arranged or configured to deposit the first printing material in a first direction, A, and to move linearly perpendicular along the axis, x, perpendicular to the first direction, A. The first nozzle(s) is (are) further configured to create layers of deposited first printing material stacked in a direction, z, opposite to the first direction, A. Hence, by depositing first printing material, the first nozzle is configured to create layers of deposited first printing material which are stacked in the direction, z. Furthermore, as the first nozzle is configured to deposit the first printing material in the first direction, A, the layers of deposited first printing material hereby become stacked in the direction, z, opposite to the first direction, A.

The printer head arrangement further comprises at least one second nozzle arranged to deposit a second printing material on at least one side of the layers of deposited first printing material, wherein a normal, N, of the at least one side extends perpendicular to the direction, z. Hence, the second nozzle(s) is (are) arranged or configured to deposit the second printing material on side(s) of the layers of first printing material deposited by the first nozzle(s).

The at least one first nozzle and the at least one second nozzle are arranged at a predetermined distance, D, parallel to the first direction, A, from each other, and wherein the at least one first nozzle and the at least one second nozzle are configured to simultaneously deposit the first printing material and the second printing material, respectively. Hence, the first and second nozzles are spaced apart by the predetermined distance, D, and are configured to operate simultaneously in depositing the first and second printing materials, respectively.

According to an embodiment of the present invention, the at least one second nozzle may be arranged to deposit the second printing material in a second direction, B, wherein an angle, a, between the first direction, A, and the second direction, B, is in a range from 30° to 135°. Preferably, the range may be from 30° to 110°, such as 30° to 90°. The present embodiment is advantageous in that the second printing material may be applied to the side(s) of the layers of deposited first printing material in an even more preferred angle, which may lead to even more reduced levels of stress built up within the 3D-printed object.

According to an embodiment of the present invention, the at least one first nozzle may be arranged in a vertical direction and arranged to deposit the first printing material vertically in the first direction, A. The present embodiment is advantageous in that the 3D-printed object may be constructed with a relatively high degree of stability, as the 20 layers of the first printing material build up in a vertical direction, in the opposite direction of the (vertical) first direction, A.

According to an embodiment of the present invention, a first operating temperature, T₁, of the at least one first nozzle, may be different from a second operating temperature, T₂, of the at least one second nozzle. The present embodiment is advantageous by an increased versatility of the printer head arrangement for providing different operating temperatures of the first nozzle(s) and/or first printing material upon deposition compared to the second nozzle(s) and/or second printing material upon deposition. For example, the operating nozzle temperature(s) may be varied and/or set differently in case a different viscosity of the first and/or second printing material is desirable. The present embodiment is advantageous in that the heating of the first and/or second printing material(s) may be performed in an even more efficient and/or energy-saving manner.

According to an embodiment of the present invention, at least one of T₁+20° C.<T₂ and T₁+80° C.>T₂ may be fulfilled. For the first relation, preferably T₁+25° C.<T₂ is fulfilled, more preferred T₁+30° C.<T₂, and even more preferred T₁+35° C.<T₂. For the second relation, preferably T₁+80° C.>T₂ is fulfilled, more preferred T₁+60° C.>T₂, and even more preferred T₁+50° C.>T₂. It should be noted that both (first and second) relations may be fulfilled, i.e. T₁+20° C.<T₂<T₁+80° C. Hence, the second operating temperature, T₂, of the second nozzle(s) may be higher than the first operating temperature, T₁, of the first nozzle(s) by more than 20° C., whilst still being lower than 80° C. above the first operating temperature, T₁, of the first nozzle(s). The present embodiment is advantageous in that the relatively high second operating temperature, T₂, of the second nozzle(s) provides a viscosity of the second printing material which is lower than the first printing material deposited by the first nozzle(s) with the (relatively lower) first operating temperature, T₁. In other words, the lower viscosity of the second material compared to the first printing material provides an improved wetting. Furthermore, the present embodiment of the second operating temperature, T₂, of the second nozzle(s) still being lower than 80° C. above the first operating temperature, T₁, of the first nozzle(s) is advantageous in that any deformation of the layers of the deposited first printing material is mitigated. In other words, higher temperatures of the second operating temperature, T₂, of the second nozzle(s) may deform the layers of the deposited first printing material.

According to an embodiment of the present invention, the predetermined distance, D, may correspond to a thickness, w, in the direction, z, of 1-10 layers of deposited first printing material. The present embodiment is advantageous by the possibility of depositing the second printing material on the side(s) of the layers of first printing material which have not (fully) cooled down after deposition, which may lead to even further reduced levels of stress built up within the 3D-printed object.

According to an embodiment of the present invention, the predetermined distance, D, may correspond to a thickness, w, in the direction, z, of ≥30 layers of deposited first printing material. The present embodiment is advantageous in that the reliability of the process by the printer head arrangement is increased.

According to an embodiment of the present invention, at least one of the material composition, color and texture of the first printing material may be the same as the at least one of material composition, color and texture, respectively, of the second printing material. Hence, one or more of the properties of material composition, color and texture of the first printing material may be the same as the corresponding property(ies) of the second printing material. The present embodiment is advantageous in the convenience of the same property(ies) of the first and second materials, e.g. concerning handling or the material(s), the aesthetical appearance of the 3D-printed object, cost, etc.

According to an embodiment of the present invention, the material composition of the first printing material may be the same as the material composition of the second printing material, and wherein at least one of the color and texture of the first printing material may be different from at least one of the color and texture, respectively, of the second printing material. The present embodiment is advantageous by the convenience of the same material composition of the first and second materials, e.g. concerning handling or the material(s), whereas the difference in color and/or texture may be advantageous for the aesthetical appearance of the 3D-printed object.

According to an embodiment of the present invention, the first printing material may comprise a polymer material with a first molecular weight, M₁, a first melting temperature, Tₘ₁, and a first glass transition temperature, T_{g1}, and the second printing material may comprise a polymer material with a second molecular weight, M₂, a second melting temperature, Tₘ₂, and a second glass transition temperature, T_{g2}, wherein at least one of M₁≠M₂, Tₘ₁≥Tₘ₂+20° C., and T_{g1}>T_{g2}+20° C., is fulfilled. The present embodiment is advantageous by an increased versatility of the printer head arrangement for providing different polymer materials with different molecular weights. Furthermore, the difference between the (relatively higher) first melting temperature, Tₘ₁, and/or (relatively higher) first glass transition temperature, T_{g1}, compared to the (relatively lower) second melting temperature, Tₘ₂, and/or (relatively lower) second glass transition temperature, T_{g2}, is that the second printing material is arranged to melt more easily, and, consequently, to flow easier compared to the first printing material. In turn, this may lead to an improved application of the second printing material on/to the first printing material, which may reduce the built-in stress in the 3D-printed object to an even further extent.

According to an embodiment of the present invention, the printer head arrangement may comprise a single printer head comprising the at least one first nozzle and the at least one second nozzle. The present embodiment is advantageous by the convenience and/or compactness of the first and second nozzles arranged in the single printer head. The present embodiment is further advantageous in ensuring the simultaneous operation first and second nozzles and/or movement of the first and second nozzles with respect to each other.

According to an embodiment of the present invention, the printer head arrangement may comprise at least two printer heads respectively comprising the at least one first nozzle and the at least one second nozzle.

According to an embodiment of the present invention, the printer head arrangement may be configured to control a first deposit rate, R₁, of the first printing material and a second deposit rate, R₂, of the second printing material. The present embodiment is advantageous in that the printer head arrangement may customize and/or adapt the speed of the deposition of the first and second printing materials in a convenient manner. For example, the rate or speed of the deposition may be adapted to the cooling rate of the first and/or second printing material, which may reduce the built-in stress in the 3D-printed object to an even further extent.

According to an embodiment of the present invention, there is provided a 3D-printing apparatus, comprising a printer head arrangement according to any one of the preceding embodiments. The 3D-printing apparatus may further comprise a controller for controlling a first deposit rate, R₁, of the first printing material and a second deposit rate, R₂, of the second printing material. The 3D-printing apparatus is arranged to deposit a first printing material by the at least one first nozzle, and to deposit a second printing material by the at least one second nozzle.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIGS. 1-3 are schematic views of printer heads for a 3D-printing apparatus according to exemplifying embodiments of the present invention,

FIG. 4 is a schematic view of the first and second printing materials according to exemplifying embodiments of the present invention,

FIG. 5 schematically shows a 3D-printing apparatus according to an embodiment of the present invention,

FIG. 6 schematically shows a portion of a 3D-printed object according to an embodiment of the present invention, and

FIG. 7 is a schematic flow chart diagram of a method according to an exemplifying embodiment of the present invention.

### DETAILED DESCRIPTION

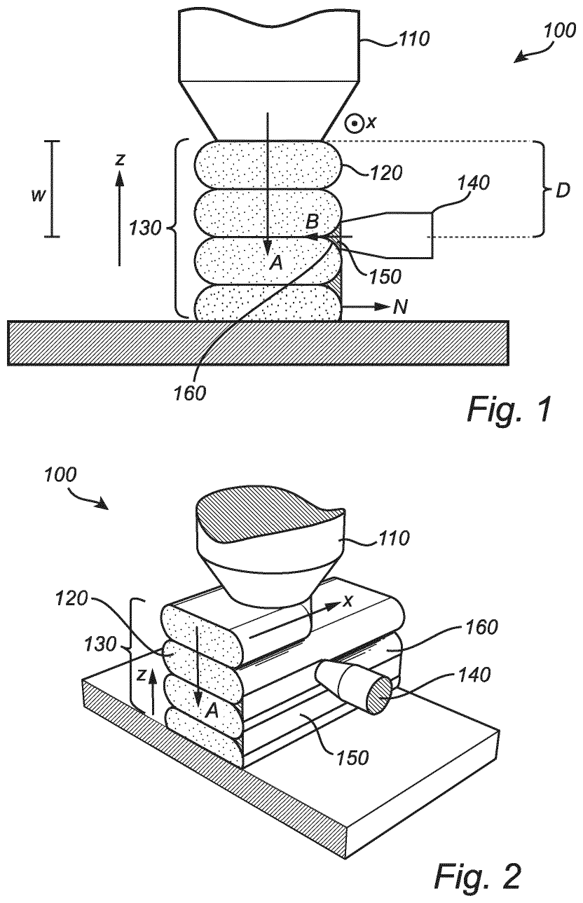

FIG. 1 is a schematic view of a printer head arrangement 100 for a 3D-printing apparatus according to an embodiment of the present invention. The printer head arrangement 100 comprises one or more first nozzles 110 (only a single first nozzle 110 is indicated/exemplified in FIG. 1) which is schematically indicated. The first nozzle 110 is arranged to move linearly along an axis, x, i.e. in the direction of the axis, x, and/or in the opposite direction of the axis, x. It should be noted that any actuating mechanism of the printer head arrangement 100 and/or the 3D-printing apparatus for the linear movement of the first nozzle 110 is omitted. The first nozzle 110 is configured to deposit a first printing material 120 in a first direction, A, perpendicular to the axis, x. In FIG. 1, it is exemplified that the first nozzle 110 is arranged in a vertical direction and is arranged to deposit the first printing material 120 vertically in the first direction, A. Hence, the first printing material 120, e.g. a material which can be extruded, such as a plastic material, is deposited by the first nozzle 110 in the first direction, A, and the first nozzle 110 moves along the axis, x, perpendicular to the first direction, A. The first nozzle 110 is further configured to create layers of deposited first printing material 120 which hereby become stacked in a direction, z, opposite to the first direction, A. Hence, and according to the example of FIG. 1, the first nozzle 110 is configured to create layers 130 of deposited first printing material 120, wherein the layers 130 of first printing material 120 are stacked on top of each other in the (vertical) direction, z. Here, four layers 130 of printing material 120 are shown, but it should be noted that the number of layers 130 may be arbitrary. The printer head arrangement 100 further comprises one or more second nozzles 140 (only a single second nozzle 140 is indicated/exemplified in FIG. 1) which is arranged to deposit a second printing material 150 on at least one side 160 of the layers 130 of deposited first printing material 120, wherein a normal, N, of the at least one side 160 extends perpendicular to the direction, z. Hence, and according to the example of FIG. 1, the second nozzle 140 is arranged or configured to deposit the second printing material 150 from a horizontal direction, on side(s) 160 of the layers 130 of first printing material 120, wherein the normal, N, of the side(s) extends horizontally. According to an example, the second nozzle 140 may be arranged or configured to deposit the second printing material 150 on a plurality of NL layers 130 of first printing material 120, wherein NL is preferably at least 3, more preferably at least 5, and even more preferred at least 10. According to another example, the second nozzle 140 may be arranged or configured to deposit the second printing material 150 on the side(s) 160 of the layers 130 of first printing material 120 such that the area of the side(s) 160 is (are) covered by second printing material 150 in a range from 20% to 80%, preferably 25% to 75%, more preferably 30% to 70%, and most preferred 35% to 65%. According to yet another example, the second nozzle 140 may be arranged or configured to deposit the second printing material 150 only on the outer (external) side(s) 160 of the layers 130 of first printing material 120, and hence not on the inner (opposite, internal) side(s) of the layers 130 of first printing material 120.

The first nozzle 110 and the second nozzle 140 are arranged at a predetermined distance, D, parallel to the first direction, A, from each other. Hence, according to FIG. 1, the predetermined distance, D, is parallel to a vertical direction, such that the first nozzle 110 and the second nozzle 140 are spaced apart in the vertical direction. According to an example, the predetermined distance, D, corresponds to a thickness, w, in the direction, z, of 1-10 layers of deposited first printing material 120. In FIG. 1, the thickness, w, is exemplified as 2 layers of deposited first printing material 120. According to an alternative example, the predetermined distance, D, may correspond to a thickness, w, in the direction, z, of ≥30 layers of deposited first printing material 120.

The first nozzle 110 and the second nozzle 140 are configured to operate simultaneously and to simultaneously deposit the first printing material 120 and the second printing material 150, respectively. According to an example, a first operating temperature, T₁, of the first nozzle 110, may be different from a second operating temperature, T₂, of the second nozzle 140. For example, the second operating temperature, T₂, may be higher than the first operating temperature, T₁, and/or lower than a specific temperature above the first operating temperature, T₁. For example, T₁+20° C.<T₂ and/or T₁+80° C.>T₂ may be fulfilled.

The printer head arrangement 100 in FIG. 1 may comprise a single printer head (not shown) which, in turn, comprises the first nozzle 110 and the second nozzle 140. Alternatively, the printer head arrangement 100 may comprise two or more printer heads respectively comprising the first nozzle 110 and the second nozzle 140.

FIG. 2 is a schematic view of a printer head arrangement 100 for a 3D-printing apparatus according to an embodiment of the present invention. It should be noted that the printer head arrangement 100 comprises many features in common with the printer head arrangement 100 as exemplified in FIG. 1 and the associated text, and it is hereby referred to FIG. 1 and the associated text for an increased understanding. Compared to FIG. 1, FIG. 2 shows the deposition of first and second printing material of the printer head arrangement 100 from another view. The first nozzle 110 is arranged to move linearly along an axis, x, i.e. in the direction of the axis, x, and is configured to deposit a first printing material 120 in a first direction, A, perpendicular to the axis, x. The first nozzle 110 is hereby configured to create layers of deposited first printing material 120 stacked in a direction, z, opposite to the first direction, A. The second nozzle 140 of the printer head arrangement is arranged to deposit the second printing material 150 on at least one side 160 of the layers 130 of deposited first printing material 120. Here, it is shown that the second nozzle 140 is configured to deposit the second printing material 150 in the furrow(s) or groove(s) of between adjacent layers of first printing material. Hence, according to this example, the second nozzle 140 of the printer head arrangement is arranged to deposit the second printing material 150 such that the deposited second printing material 150 is separated in a cross-section of the layers 130 of deposited first printing material 120. In other words, the deposited second printing material 150 does not overlap in a cross-section in the z direction of the layers 130 of deposited first printing material 120. According to an alternative example, the second nozzle 140 of the printer head arrangement is arranged to deposit the second printing material 150 such that the deposited second printing material 150 overlaps in a cross-section in the z direction of the layers 130 of deposited first printing material 120 (not shown in FIG. 2).

FIG. 3 is a schematic view of a printer head arrangement 100 for a 3D-printing apparatus according to an embodiment of the present invention. It should be noted that the printer head arrangement 100 comprises many features in common with the printer head arrangement 100 as exemplified in FIG. 1 and/or FIG. 2 and the associated text(s), and it is hereby referred to this (these) figure(s) and the associated text(s) for an increased understanding. In FIG. 3, the second nozzle 140 is arranged to deposit the first printing material 120 in a second direction, B, wherein an angle, a, between the first direction, A, and the second direction, B, is in a range from 30° to 135°, preferably 30° to 90°. Hence, and according to the example of FIG. 2, the second nozzle 140 is inclined with respect to the horizontal direction.

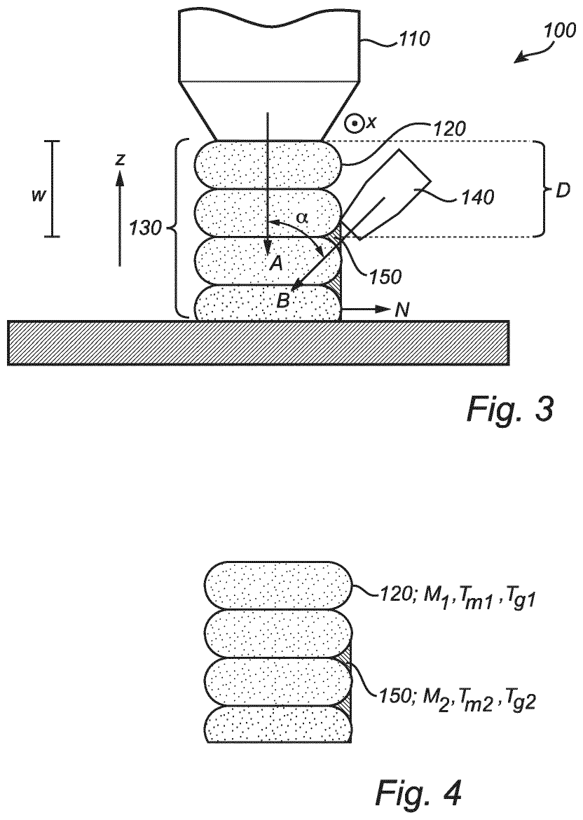

FIG. 4 is a schematic view of the first printing material 120 and the second printing material 150 and the properties thereof. According to an example, one or more of the material composition, color and texture of the first printing material 120 is the same as the corresponding material composition, color and texture, respectively, of the second printing material 150. Alternatively, the material composition of the first printing material 120 may be the same as the material composition of the second printing material 150, and wherein the color and/or texture of the first printing material 120 is different from the corresponding color and/or texture, respectively, of the second printing material 150. According to yet another example, the first printing material 120 comprises a polymer material with a first molecular weight, M₁, a first melting temperature, Tₘ₁, and a first glass transition temperature, T_{g1}, and the second printing material 150 comprises a polymer material with a second molecular weight, M₂, a second melting temperature, Tₘ₂, and a second glass transition temperature, T_{g2}, wherein one or more of the following relations is (are) fulfilled: M₁ #M₂ (i.e. the polymer material of the first printing material 120 has a first molecular weight, M₁, which is different from the second molecular weight, M₂, of the polymer material of the second printing material 120), Tₘ₁≥ Tₘ₂+20° C. (i.e. that the first melting temperature, Tₘ₁, of the first printing material 120 is higher than the second melting temperature, Tₘ₂, of the second printing material 150), and T_{g1}≥T_{g2}+20° C. (i.e. that the first glass transition temperature, T_{g1}, of the first printing material 120 is higher than the second glass transition temperature, T_{g2}, of the second printing material 150).

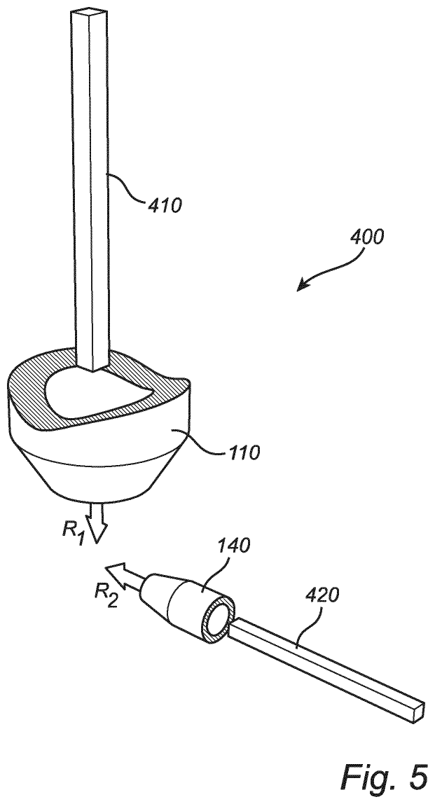

FIG. 5 schematically shows a 3D-printing apparatus 400 according to an embodiment of the present invention. The 3D-printing apparatus 400 comprises a printer head arrangement according to any one of the preceding embodiments, which in turn comprises a first nozzle 110 and a second nozzle 140. The 3D-printing apparatus 400 further comprises a first printing material 410 arranged to be deposited by the first nozzle 110, and a second printing material 420 arranged to be deposited by the second nozzle 140. It should be noted that the length and form of the first and second printing materials 410, 420 are schematical. According to an example, the printer head arrangement or the 3D-printing apparatus is configured to control a first deposit rate, R₁, of the first printing material 110 and a second deposit rate, R₂, of the second printing material 140.

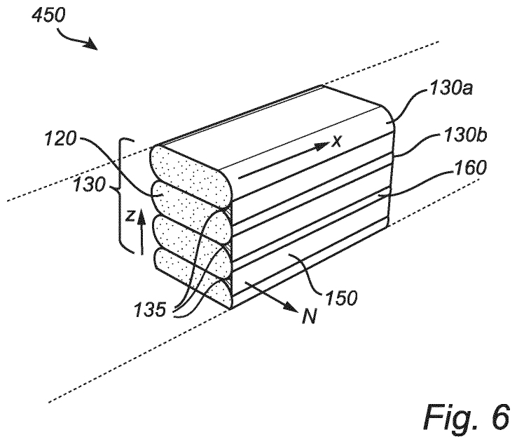

FIG. 6 schematically shows a portion of a 3D-printed object 450 according to an embodiment of the present invention. It should be noted that the 3D-printed object 450 may be substantially any object, and that FIG. 6 schematically illustrates a section or portion of such an object 450. The 3D-printed object 450 comprises a plurality of layers 130 of deposited first printing material 120. Each layer of the plurality of layers 130 at least partially extends along an axis, x, and the plurality of layers 130 is stacked in a direction, z, perpendicular to the axis, x. The plurality of layers 130 comprises at least one side portion 160, wherein a normal, N, of the side portion(s) 160 extend(s) perpendicular to the axis, x, and perpendicular to the direction, z. The profile of the plurality of layers 130 comprises bulges of deposited first printing material 120 at the side portion(s) 160 thereof, resulting in furrows, grooves, or the like. Hence, the plurality of layers 130 comprises respective furrows 135 between at least one pair 130a, 130b of adjacent layers of the plurality of layers 130. The furrow(s) 135 extend(s) parallel to the axis, x, and in an opposite direction of the normal, N. The 3D-printed object 450 further comprises second printing material 150 in at least a portion of the at least one furrow 135.

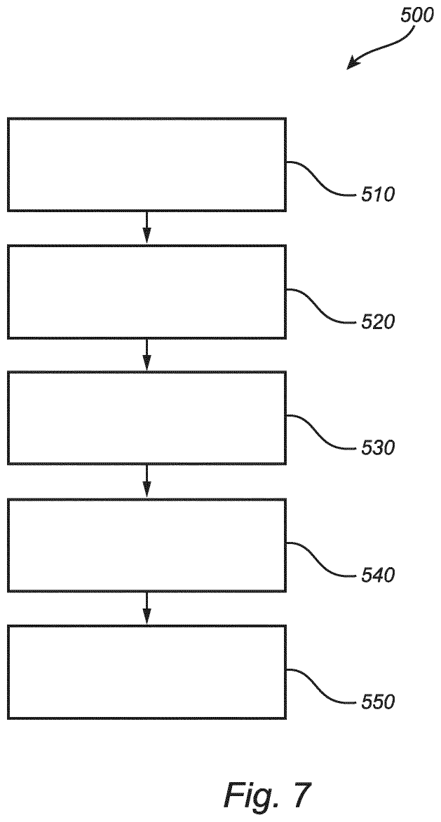

FIG. 7 is a schematic flow chart diagram of a 3D-printing method 500 according to an exemplifying embodiment of the present invention. The method 500 comprises the step of providing 510 a printer head arrangement comprising at least one first nozzle and at least one second nozzle. The method 500 further comprises linearly moving 520 the at least one first nozzle along an axis, x, and depositing 530, by the at least one first nozzle, a first printing material in a first deposit direction, A, perpendicular to the axis, x. The method 500 further comprises creating 540 layers of deposited first printing material stacked in a direction, z, opposite to the first direction, A. The method 500 further comprises depositing 550, by the at least one second nozzle, a second printing material on at least one side of the layers of deposited first printing material, wherein a normal, N, of the at least one side extends perpendicular to the first direction, z, wherein the at least one first nozzle and the at least one second nozzle are arranged at a predetermined distance, D, parallel to the first direction, A, from each other, and wherein the depositing of the first printing material and the depositing of the second printing material are performed simultaneously.

The person skilled in the art realizes that the present invention by no means is limited to the preferred embodiments described above. On the contrary, many modifications and variations are possible within the scope of the appended claims. For example, it will be appreciated that the figures are merely schematic views of printer head arrangements according to embodiments of the present invention. Hence, any elements/components of the printer head arrangement 100 such as the first nozzle 110 and/or the at least one second nozzle 140 may have different dimensions, shapes and/or sizes than those depicted and/or described. For example, the first nozzle 110 and/or the second nozzle(s) 140 may be larger or smaller than what is exemplified in the figures.

1. A printer head arrangement for a 3D-printing apparatus, comprising:
at least one first nozzle arranged to move linearly along an axis, x, and to deposit a first printing material in a first direction, A, perpendicular to the axis, x, and to create layers of deposited first printing material stacked in a direction, z, opposite to the first direction, A,
at least one second nozzle arranged to deposit a second printing material on at least one side of the layers of deposited first printing material, wherein a normal, N, of the at least one side extends perpendicular to the axis, x, and perpendicular to the direction, z,
wherein the at least one first nozzle and the at least one second nozzle are arranged at a predetermined distance, D, parallel to the first direction, A, from each other, and wherein the at least one first nozzle and the at least one second nozzle are configured to simultaneously deposit the first printing material and the second printing material, respectively.

2. The printer head arrangement according to claim 1, wherein the at least one second nozzle is arranged to deposit the second printing material in a second direction, B, wherein an angle, α, between the first direction, A, and the second direction, B, is in a range from 30° to 135°.

3. The printer head arrangement according to claim 1, wherein the at least one first nozzle is arranged in a vertical direction and arranged to deposit the first printing material vertically in the first direction, A.

4. The printer head arrangement according to claim 1, comprising a single printer head comprising the at least one first nozzle and the at least one second nozzle.

5. The printer head arrangement according to claim 1, comprising at least two printer heads respectively comprising the at least one first nozzle and the at least one second nozzle.

6. A 3D-printing apparatus comprising: a printer head arrangement according to claim 1, wherein the 3D-printing apparatus further comprises a controller for controlling a first deposit rate, R₁, of the first printing material and a second deposit rate, R₂, of the second printing material.

7. A 3D-printed object, comprising:
a plurality of layers of deposited first printing material, wherein each layer of the plurality of layers at least partially extends along an axis, x, wherein the plurality of layers is stacked in a direction, z, perpendicular to the axis, x, and wherein the plurality of layers comprises at least one side portion, wherein a normal, N, of the at least one side portion extends perpendicular to the axis, x, and perpendicular to the direction, z,
wherein the at least one side portion of the plurality of layers comprises at least one furrow between at least one pair of adjacent layers of the plurality of layers, wherein the at least one furrow extends parallel to the axis, x, and in an opposite direction of the normal, N, and
deposited second printing material provided in at least a portion of the at least one furrow.

8. A 3D-printing method, comprising the steps of:
providing a printer head arrangement according to claim 1,
linearly moving the at least one first nozzle along an axis, x, and depositing, by the at least one first nozzle, a first printing material in a first deposit direction, A, perpendicular to the axis, x,
creating layers of deposited first printing material stacked in a direction, z, opposite to the first direction, A,
depositing, by the at least one second nozzle, a second printing material on at least one side of the layers of deposited first printing material, wherein a normal, N, of the at least one side extends perpendicular to the first direction, z, wherein the at least one first nozzle and the at least one second nozzle are arranged at a predetermined distance, D, parallel to the first direction, A, from each other, and
wherein the depositing of the first printing material and the depositing of the second printing material are performed simultaneously.

9. The 3D printing method according to claim 8, wherein a first operating temperature, T₁, of the at least one first nozzle, is different from a second operating temperature, T₂, of the at least one second nozzle, and wherein at least one of
$${T}_{1} + 20 ° C . < {T}_{2} , and$$
$${T}_{1} + 80 ° C . > {T}_{2} ,$$
is fulfilled.

10. The 3D printing method according to claim 8, wherein the predetermined distance, D, corresponds to a thickness, w, in the direction, z, of 1-10 layers of deposited first printing material.

11. The 3D printing method according to claim 8, wherein the predetermined distance, D, corresponds to a thickness, w, in the direction, z, of ≥30 layers of deposited first printing material.

12. The 3D printing method according to claim 8, wherein at least one of the material composition, color and texture of the first printing material is the same as the at least one of material composition, color and texture, respectively, of the second printing material.

13. The 3D printing method according to claim 8, wherein the material composition of the first printing material is the same as the material composition of the second printing material, and wherein at least one of the color and texture of the first printing material is different from at least one of the color and texture, respectively, of the second printing material.

14. The 3D printing method according to claim 8, wherein
the first printing material comprises a polymer material with a first molecular weight, M₁, a first melting temperature, Tₘ₁, and a first glass transition temperature, T_{g1}, and
the second printing material comprises a polymer material with a second molecular weight, M₂, a second melting temperature, Tₘ₂, and a second glass transition temperature, T_{g2},
wherein at least one of
$${M}_{1} \neq {M}_{2} ,$$
$${T}_{m 1} \geq {T}_{m 2} + 20 ° C . , and$$
$${T}_{g 1} \geq {T}_{g 2} + 20 ° C . ,$$
is fulfilled.
